(19) United States
(12) Patent Application Publication
(10) Pub. No.: US 2010/0156893 A1
(43) Pub. Date: Jun. 24, 2010

(54) Information visualization device and information visualization method

(75) Inventors: Isao Mihara, Tokyo (JP); Masahiro Sekine, Tokyo (JP); Yasukazu Higuchi, Kawasaki-Shi (JP); Norihiro Nakamura, Kawasaki-Shi (JP); Yasunobu Yamauchi, Kawasaki-Shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/585,458

(22) Filed: Sep. 15, 2009

(30) Foreign Application Priority Data
Dec. 22, 2008 (JP) 2008-242742

(51) Int. Cl. G06T 15/00; G06F 3/01

(52) U.S. Cl. 345/419; 715/761

(57) ABSTRACT

An information visualization device includes: a content specifier specifying a desired content item in a database; a first display information generator generating first display information by combining first meta-information items out of the meta-information items included in the desired content item; a second display information generator generating second display information by combining second meta-information items out of the meta-information items included in the desired content item; a display information placer generating an information CG model by placing the first and second display information on first and second surfaces of the CG model; a CG model attitude determiner determining an attitude of the information CG model in a virtual space so that the first or second surface is visible from a virtual viewpoint; and a CG model placer placing the information CG model with a determined attitude in the virtual space according to the position information.

### CROSS REFERENCE TO RELATED APPLICATIONS

This application is based upon and claims the benefit of priority from the prior Japanese Patent Application No. 2008-242742, filed on Sep. 22, 2008, the entire contents of which are incorporated herein by reference.

### BACKGROUND OF THE INVENTION

1. Field of the Invention

The present invention relates to an information visualization device and an information visualization method to display content information to a user in a visible way.

2. Related Art

A graphical user interface (GUI) etc. are provided in an audio-video (AV) device such as a television and videocassette recorder, personal computer (PC) having an AV function, etc. By operating the GUI, a user timer-records and watches content such as a television program.

With such a GUI, content information such as a television program is comprehensibly visualized on a screen, by which the user can easily identify a plurality of content items on the GUI screen. For example, in a GUI for showing a list of programs recorded by a video recorder etc., a plurality of content items are placed on the screen in a tiled manner, and each content item is represented as a combination of information items such as a thumbnail, title, air date and time, etc. of the program. Accordingly, the user visually identifies each content item. These days, a GUI called Electric Program Guide (EPG), which is a copy of a television schedule in the newspaper displayed on the screen, is widely used to timer-record a television program to be aired in the future. In the EPG, a plurality of content items are placed like the television schedule in the newspaper, and each content item is visualized as a combination of the information items such as a title, synopsis, broadcast channel, air time, etc.

As stated above, in a recent GUI intended for the AV device and PC, a plurality of content items are placed on one screen, and each content item is displayed by combining its information items. That is, when a specific content item such as a television program is visualized, display information is formed by combining the information items such as a thumbnail, title, details, etc. of the program.

When many program information items placed in a three-dimensional space are required to be identified at one view, there is a problem that the program information items are equally visualized at the same time and are not comprehensible. Accordingly, JP-A 2004-178085 discloses a visualization technique to change the information items to be displayed corresponding to the “apparent size” (three-dimensional distance from a viewpoint) of the program information items.

Recently, it has been increasingly required for a GUI as stated above to be highly expressed, and a GUI three-dimensionally expressed by using a computer graphics (CG) technique has been increasing. Such a three-dimensional GUI can be realized by placing, in a CG space expressed in the three-dimensional space, each content item which is three-dimensionally expressed as a CG model.

As stated above, in a three-dimensional GUI expression using the CG technique, the content information items can be displayed based on the control corresponding to various factors or situations such as a three-dimensional position, attitude and form of the CG model, method to map the information of the content item to the CG model, and viewpoint position, light source position, and application requirements to visualize the three-dimensional CG space. The above JP-A 2004-178085 focuses only on the “apparent size” to control the content information. In the three-dimensional GUI expression, the display information of the content cannot be appropriately controlled corresponding to the situations in the three-dimensional space in case that the control is based only on the “apparent size” as stated above.

### SUMMARY OF THE INVENTION

According to an aspect of the present invention, there is provided an information visualization device which places and displays a CG model having two or more surfaces in a virtual space, comprising:

a content database storing one or more content items, each of which including a plurality of meta-information items;

a content specifier configured to specify a desired content item in the content database;

a first display information generator configured to generate first display information by combining one or more first meta-information items out of the meta-information items included in the desired content item;

a second display information generator configured to generate second display information by combining one or more second meta-information items out of the meta-information items included in the desired content item, the second display information having a different information amount from that of the first display information;

a display information placer configured to generate an information CG model by placing the first display information on a first surface of the CG model and by placing the second display information on a second surface of the CG model, the first surface and the second surface being different from each other;

an information receiver configured to receive information representative of a virtual viewpoint and position information of the information CG model in the virtual space from an external device;

a CG model attitude determiner configured to determine an attitude of the information CG model in the virtual space so that the first surface or the second surface is visible from the virtual viewpoint when the information CG model is placed according to the position information in the virtual space;

a CG model placer configured to place the information CG model with a determined attitude in the virtual space according to the position information; and

a display configured to display the information CG in the virtual space from the virtual viewpoint.

### BRIEF DESCRIPTION OF THE DRAWINGS

FIG. 1 is a diagram schematically showing a structural example of an information visualization device according to a first embodiment of the present invention.

FIG. 2 is a diagram showing an example of a CG model having at least two surfaces.

FIG. 3 is a diagram to explain a process performed by a first surface display information placer.

FIG. 4 is a diagram to explain a process performed by a second surface display information placer.

FIG. 5 is a diagram showing the relationship between an attitude of the CG model and a visualization screen.

FIG. 6 is a diagram schematically showing a structural example of an information visualization device according to a second modification example of the first embodiment of the present invention.

FIG. 7 is a diagram to explain a process performed by a placement attribute generator.

FIG. 8 is a diagram schematically showing a structural example of an information visualization device according to a second embodiment of the present invention.

FIG. 9 is a diagram to explain an effect of the second embodiment of the present invention.

FIG. 10 is a diagram to explain an effect of the second embodiment of the present invention subsequent to FIG. 9.

FIG. 11 is a diagram schematically showing a structural example of an information visualization device according to a third embodiment of the present invention.

FIG. 12 is a diagram schematically showing a structural example of an information visualization device according to a first modification example of the third embodiment of the present invention.

FIG. 13 is a diagram showing information CG models placed in a virtual space and seen from a certain virtual viewpoint.

FIG. 14 is a diagram showing information CG models placed in a virtual space and seen from another virtual viewpoint.

### DETAILED DESCRIPTION OF THE INVENTION

Embodiments according to the present invention will now be explained with reference to the accompanying drawings.

### First Embodiment

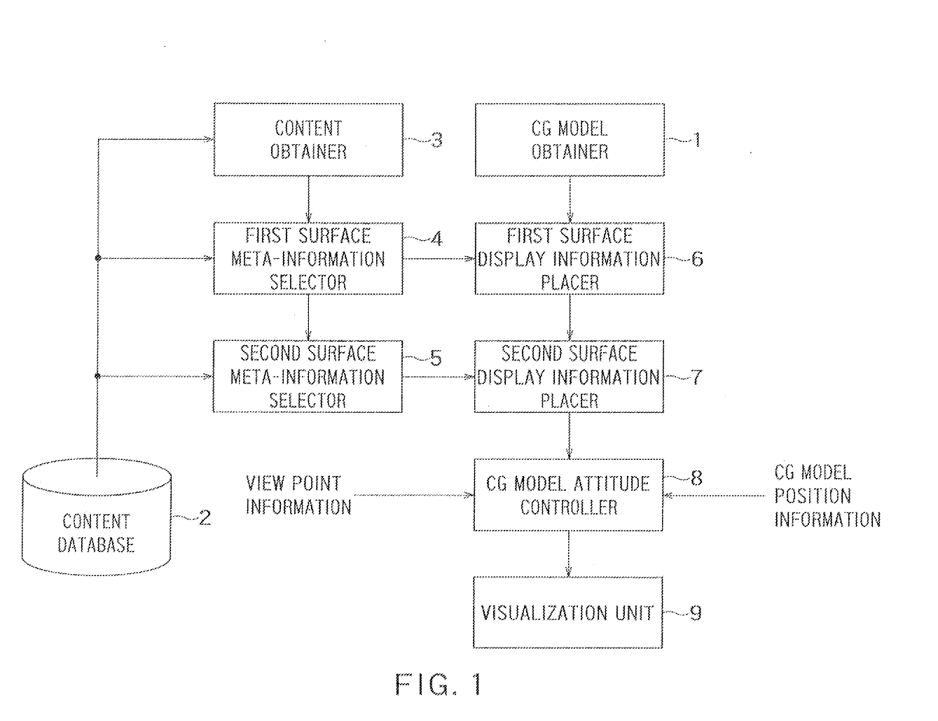

FIG. 1 is an overall block diagram of an information visualization device according to a first embodiment of the present invention.

A visualization device of the present embodiment includes: a CG model obtainer 1; a content database 2; a content obtainer 3; a first surface meta-information selector 4; a second surface meta-information selector 5; a first surface display information placer 6; a second surface display information placer 7; a CG model attitude controller 8; and a visualization unit 9.

The CG model obtainer 1 obtains a CG model having two or more surfaces.

The content database 2 stores one or more content items, each of which includes a plurality of meta-information items.

The content obtainer 3 specifies a desired content item stored in the content database 2.

The first surface meta-information selector 4 selects one or more meta-information (first meta-information) items from the plurality of meta-information items of the specified content item.

The first surface display information placer 6 generates first display information by combining the meta-information (first meta-information) items selected by the first surface meta-information selector 4, and places the generated first display information on a first surface of the CG model.

The second surface meta-information selector 5 selects, from the plurality of meta-information items of the specified content item, one or more meta-information (second meta-information) items which are the same as or different from the first meta-information.

The second surface display information placer 7 generates second display information having a different information amount from that of the first display information by combining the meta-information (second meta-information) items selected by the second surface meta-information selector 5, and places the generated second display information on a second surface of the CG model. The CG model having the first and second display information placed on the first and second surfaces respectively is called an information CG model.

The CG model attitude controller 8 receives viewpoint information representing a virtual viewpoint given in a virtual space and position information of the information CG model in the virtual space. The CG model attitude controller 8 controls (determines) the attitude of the information CG model so that the first surface or the second surface is visible from the virtual viewpoint when the information CG model is placed in the position corresponding to the received position information.

The visualization unit 9 places the information CG model having the determined attitude in the position corresponding to the position information in the CG space, and displays the CG space having the information CG model from the virtual viewpoint.

Hereinafter, the details of the components 1 to 9 will be explained.

### <CG Model Obtainer>

The CG model obtainer 1 obtains a CG model having at least two surfaces by reading it from the outsurface (for example, an external device). More specifically, the CG model obtainer 1 receives from the outsurface a file having the information of the CG model described in a predetermined format, and interprets the file to obtain the information of the CG model such as vertex information, surface information (or information of connected vertexes), primitive information (or technical information to connect the vertexes), material information, color information, texture information, etc. In this case, the CG model obtainer 1 has a function to distinguish and determine arbitrary two surfaces of the CG model having at least two surfaces.

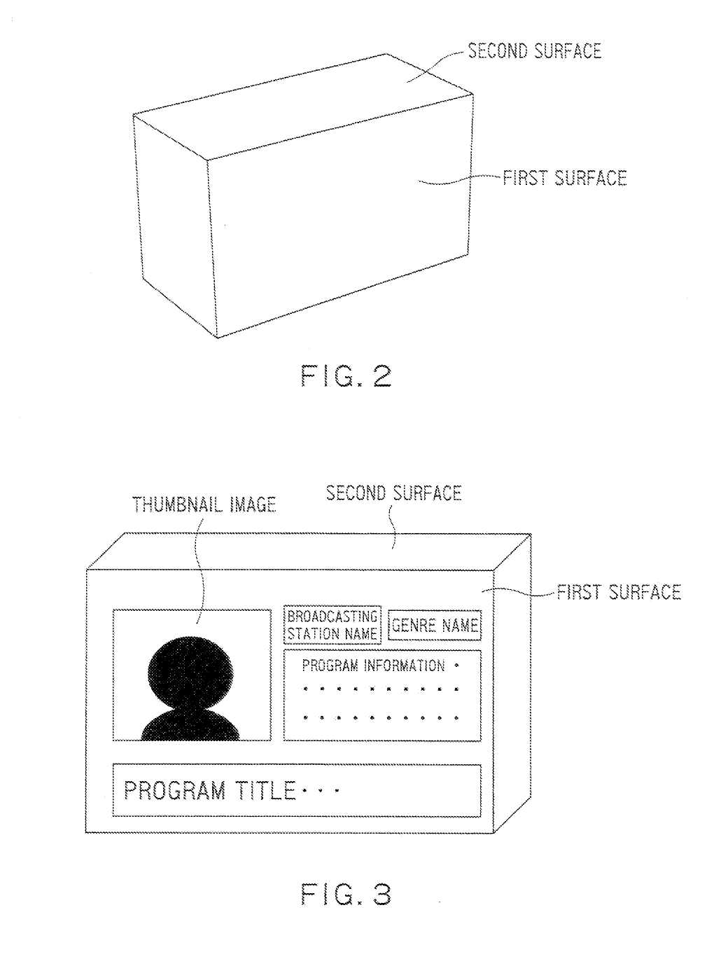

FIG. 2 shows an example of the CG model. The CG model is a rectangular solid having six surfaces. In this example, it is determined that a front surface is the first surface and the upper surface is the second surface when seen from a viewpoint (not shown). The CG model obtainer 1 reads, from the outsurface, a file describing such a CG model.

### <Content Database>

The content database 2 accumulates at least one or more content data items (i.e. content items). Here, the content data is media data having a specific category such as the data concerning a recorded past television program, television program on the air, television program to be aired in the future, moving picture such as a movie, still image shot by a digital camera, music album or a single, etc.

The structure of the content data will be explained in detail. One content data item is formed of at least one or more meta-information items. Here, the meta-information data is data to express the substance of the content or additional information to explain the substance of the content. Generally, the substance of the content is rarely called meta-information. However, the meta-information in the present embodiment includes the data to express the substance of the content and the additional information to explain the substance of the content, since there is no need to distinguish one from the other.

For example, when the content item is a television program, the meta-information item is obtained by dividing the information of the television program on an information item basis. For example, concrete meta-information items of the television program are: an airdate; airtime; channel (or broadcasting station) name of the program to be aired (or already aired); program title; program subtitle; program information; cast names; genre; and sub-genre. These information items are often recorded in the format of an EPG. The EPG can be provided in combination with digital terrestrial television airwaves, or distributed on the Internet (as iEPG proposed by Sony Corporation, for example). The recorded information items are generally as stated above regardless of the format type of the EPG. Further, when the content item is a recorded television program, the following are also included in the meta-information items, namely, a moving picture of the substance of the broadcasted program (normally in a format such as AVI, MPEG2, MPEG4, H.264, etc.) and a thumbnail image which is an frame image arbitrarily acquired from the moving picture and processed (to reduce the resolution of the frame image, for example). The content data of the television program is formed of a combination of the meta-information items as stated above.

Further, when the content item is a still image shot by a digital camera, the content data is formed of the following meta-information items, for example: camera parameters such as shooting date and time, camera name, shooting resolution, exposure information, lens information, etc.; shooting information (normally recorded in EXIF format etc.) such as shooting location information (for example, GPS information concerning latitude and longitude); and shot image (normally recorded in an image format of RAW, JPEG, etc.)

Further, when the content item is a music album, the content data is formed of the following various meta-information items, for example: an album title; artists; number of music titles; music titles; song length; composers; arrangers; participant musicians; genre; and music data of the wave patterns of the music titles (normally recorded in a format of WAV, MP3, etc.)

### <Content Obtainer>

The content obtainer (content specifier) 3 inquires the content database if a desired content item is existent in the database by using a function of the content database 2. When the desired content item is existent, the content obtainer 3 takes it out, and transmits the desired content item or the identification information thereof to the first surface meta-information selector 4 and the second surface meta-information selector 5. That is, the content obtainer 3 specifies a desired content item stored in the content database 2, and notifies the specified content item to the first surface meta-information selector 4 and the second surface meta-information selector 5. The CG model obtainer 1 can obtain the CG model corresponding to or regardless of the content item specified by the content obtainer 3.

### <First Surface Meta-information Selector>

The first surface meta-information selector 4 selects one or more meta-information items from a plurality of meta-information items of the content item sent from the content obtainer 3. A set of the selected meta-information items is called a first meta-information set. Note that when the first surface meta-information selector 4 receives content identification information from the content obtainer 3, the first surface meta-information selector 4 accesses the content database 2 to read the content item having thisurfacentification information, and selects one or more meta-information items from the read content item.

Hereinafter, an example will be explanation based on a case where the content data is a recorded television program. Note that this is merely one example, and the present invention is not limited thereto.

As stated above, when the content item is a recorded television program, the content item includes a plurality of meta-information items such as: an airdate; airtime, program title; program subtitle; program information; cast names; genre; sub-genre; moving picture of the substance of the broadcasted program; and thumbnail image which is an frame image arbitrarily acquired and processed based on the moving picture.

The first surface meta-information selector 4 selects at least one or more meta-information items from a wide variety of meta-information items of the content item (in this case, a recorded television program), and obtains the first meta-information set representing a set of the selected meta-information items. For example, the first surface meta-information selector 4 selects the meta-information items such as a thumbnail image, program title, broadcasting station name, genre name, and program information, etc. and obtains the first meta-information set formed of these meta-information items.

The meta-information items are selected in accordance with the following two references:

(1) A predetermined combination of the meta-information items is used, and

(2) Elements (meta-information items) are selected or changed through dialogue with a user.

In an example where the predetermined combination of the meta-information items is used, a plurality of templates, each of which has a typical combination, are stored in the first surface meta-information selector 4, and employed from the template group is a template indicated by the user or a template selected corresponding to the situation of the CG model such as the size of the surface, color, form, etc. (template corresponding to the situation is predetermined).

### <Second Surface Meta-Information Selector>

The second surface meta-information selector 5 selects one or more meta-information items from a plurality of meta-information items of the content item sent from the content obtainer 3. The meta-information items selected by the second surface meta-information selector 5 and those selected by the first surface meta-information selector 4 can be completely the same or completely or partially different from each other. Note that when the second surface meta-information selector 5 receives content identification information from the content obtainer 3, the second surface meta-information selector 5 accesses the content database 2 to read the content item having thisurfacentification information, and selects one or more meta-information items from the read content item. A set of meta-information items selected by the second surface meta-information selector 5 is referred to as a second meta-information set. The second surface meta-information selector 5 selects the meta-information items in accordance with the references similar to those of the first surface meta-information selector 4.

### <First Surface Display Information Placer>

The first surface display information placer 6 generates the first display information by combining the first meta-information set obtained by the first surface meta-information selector 4, and places the generated first display information on the first surface of the CG model. Specifically, attributes needed for visualization is determined with respect to each of the plurality of meta-information items of the first display information, and each meta-information item is placed on the first surface of the CG model in accordance with the determined attributes. For example, when the meta-information is character string information, the attributes needed for visualization are:

(1) The size and position of the region in which the character string is placed, and how to place the character string (whether or not to turn the character string in the placement region, for example);

(2) Attributes (color of the placement region etc.) to visualize the placement region; and

(3) Attributes (font, font size, font color, etc.) to visualize the character string.

When the meta-information item is image information, the attributes needed for visualization are:

(1) The size and position of the region in which the image is placed;

(2) Attributes (color of the placement region etc.) to visualize the placement region; and

(3) Attributes (permeation rate of the image, mapping technique of the image (to scale the image corresponding to the size of the region, and to clip the image corresponding to the form of the region, for example)) to visualize the image.

After determining the above attributes, each meta-information item is placed on the first surface of the CG model in accordance with the determined attributes (that is, the first display information is generated by combining the meta-information items in accordance with the determined attributes, and the generated first display information is placed on the first surface of the CG model). When the meta-information item is an image, a CG technique called texture mapping can be used as a method to place the first display information. When the meta-information item is a character string, the character string can be converted into a visible image in accordance with the above attributes and be placed on the first surface by using a similar technique to the above texture mapping. It is also possible to place the character information of the character string directly on the first surface by using a technique disclosed by JP-A 2007-241878 (Kokai).

Here, a first surface display information generator of the present invention corresponds to the first surface meta-information selector 4 for selecting the meta-information items and the first surface display information placer 6 for combining the meta-information items (for determining the attributes of the meta-information). Further, a display information placer of the present invention corresponds to the first surface display information placer 6 to place the meta-information items (first display information).

Hereinafter, how the first surface display information placer 6 places the meta-information items (first display information obtained by combining the meta-information items) will be specifically explained by using an example of a television program.

FIG. 3 shows an example in which the meta-information items selected by the first surface meta-information selector 4 (the first display information obtained by combining the meta-information items) are placed on the first surface of the CG model in accordance with each attribute. There are five meta-information items: a thumbnail image; program title; broadcasting station name; genre name; and program information. Each meta-information item is placed on the first surface based on a predetermined placement attribute. The thumbnail image having a length of h pixels and a width of w pixels is placed in the position which is (x, y) pixels apart from the upper left of the first surface. Next to the thumbnail image, the broadcasting station name having a font size of s1 points is placed in one line in a region having a width of w1. The genre name having a font size of s2 points is placed in one line in the region having a width of w2. The program synopsis having a font size of s3 points is placed in n lines in the region having a width of w3 and a height of h3. At the bottom of the first surface, the program title is placed in one line in the region having a width of w4.

Note that, as in the references to select the meta-information items, the attributes for placing are selected in accordance with the following two references:

(1) Predetermined attributes are used, and

(2) Attributes are selected or changed through dialogue with a user.

In an example where the predetermined attributes are used, a plurality of templates, each of which has typical placement attributes, are stored in the first surface meta-information selector 4, and employed from the template group is a template indicated by the user or a template selected corresponding to the situation of the CG model such as the size of the surface, color, form, etc. (template corresponding to the situation is predetermined).

### <Second Surface Display Information Placer>

The second surface display information placer 7 generates the second display information so that the second display information has a different information amount from that of the first display information by combining the second meta-information set obtained by the second surface meta-information selector 5, and places the generated second display information on the second surface of the CG model with the first display information being previously placed on the first surface. Specifically, attributes needed for visualization are determined with respect to each of the plurality of meta-information items, and each meta-information item is placed on the second surface of the CG model in accordance with the determined attributes so that the meta-information set placed on the second surface has a different information amount from that of the meta-information set placed on the first surface.

Here, the information amount is defined by at least one of the following references.
The number of meta-information items selected;
The type of the meta-information item selected;
When the meta-information item is an image or an alternative corresponding to the image (for example, an arbitrary frame image of a video (moving picture), one or more items selected from the size (width or height) of the image, number of colors, and gradation (depth value of the image);
When the meta-information item is a video (moving picture), one or more items selected from a frame image to be displayed (at a determined time t), number of frame images for display, size of the frame image (width or height), number of colors, and gradation (depth value of the image); and
When the meta-information item is a character string, the number of characters to be displayed (for example, 5 characters from the head when the meta-information is expressed by 10 characters), the size of the characters, the font information of the characters, the color information of the characters (character color or background color), layout of the characters (columnar writing or horizontal writing, for example), and decoration of the characters (expression given to the characters by using a underline, subscript, superscript, marker, moving border, shading, scaling, etc., for example)

Based on the above definitions, when the number or types of the meta-information items of the second meta-information set is different from those of the first meta-information set, the information amount of the first display information (first surface) and the information amount of the second display information (second surface) become naturally different from each other regardless of the combination method (i.e. determination method of the placement attributes). For example, when the first meta-information set includes five meta-information items of a thumbnail image, program title, broadcasting station name, genre name, and program information while the second meta-information set includes two meta-information items of a thumbnail image and program title as display information, the information amount of the first display information and that of the second display information become naturally different from each other regardless of the combination method (determination method of the placement attributes).

On the other hand, when the same number and types of meta-information items are selected by the first surface meta-information selector 4 and the second surface meta-information selector 5, the first meta-information set and the second meta-information set (placement attributes) should be combined (determined) so that the elements (for example, size, the number of colors expressed, etc.) other than the number and the types become different between the first and second display information.

Here, a second surface display information generator of the present invention corresponds to the second surface meta-information selector 5 for selecting the meta-information items, and the second surface display information placer 7 for combining the meta-information items (for generating the second display information so that the second display information has a different information amount from the first display information). Further, the display information placer of the present invention corresponds to the second surface display information placer 7 to place the meta-information items (first display information).

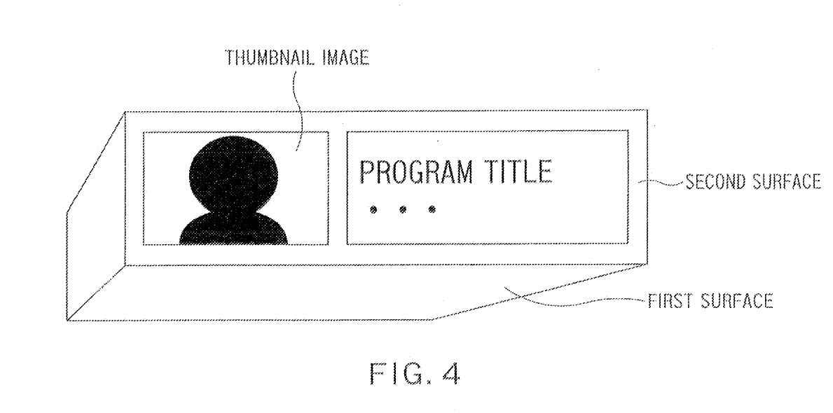

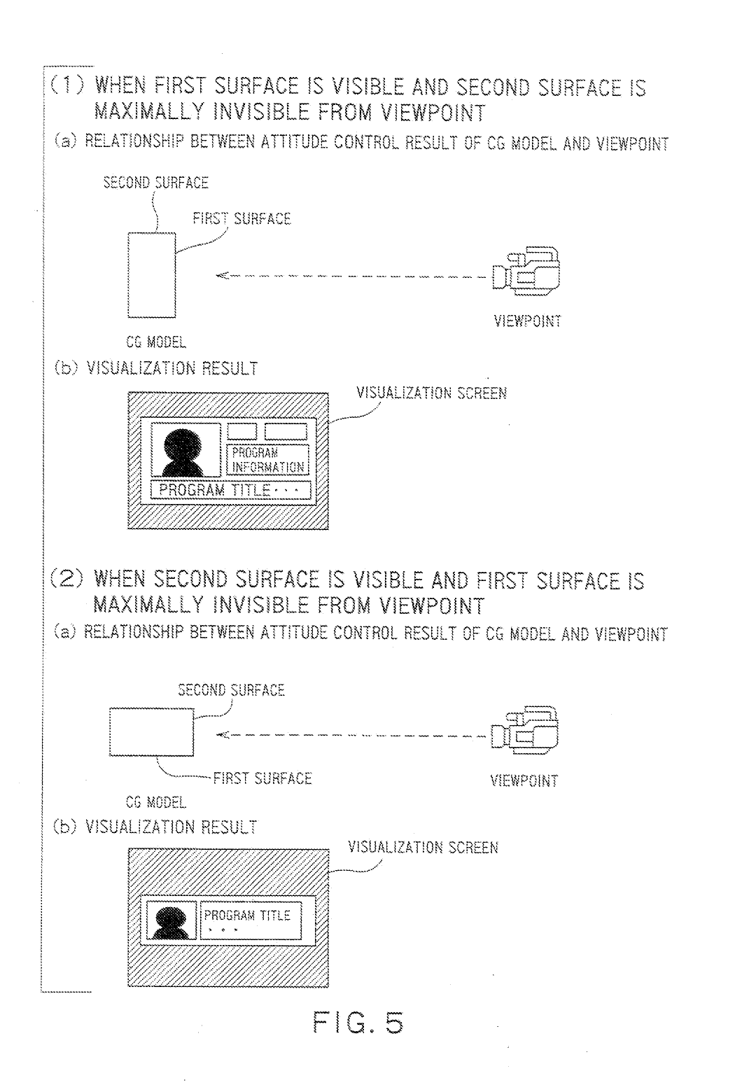

FIG. 4 shows an example in which the meta-information items selected by the second surface meta-information selector 5 is placed on the second surface of the CG model in accordance with each attribute (the second display information obtained by combining the meta-information items is placed on the second surface). Two meta-information items, namely, a thumbnail image and program title are provided. Each meta-information item is placed on the second surface based on predetermined placement attributes.

Comparing with the first surface (see FIG. 3), the amount of the second display information is different from that of the first display information. That is, the number (two) of meta-information items in the second display information is different from the number (five) of meta-information items in the first display information. Further, with respect to the thumbnail image and program title, which are the meta-information items included in both of the first and second display information, the attributes of the placement position and placement size in the first display information are different from those in the second display information, which leads to the difference in information amount between the first and second display information.

### <CG Model Attitude Controller>

The attitude of the CG model having the first surface and the second surface, on which the meta-information (the first and second display information) is placed in accordance with each attribute, is controlled by the CG model attitude controller 8 by using the viewpoint information for CG visualization (information on the virtual viewpoint given in the CG space (the virtual space)) and visualization position information of the CG model (the position information when the CG model is placed in the CG space). In other words, the CG model attitude controller 8 determines the attitude of the information CG model so that the first surface or the second surface is visible from the virtual viewpoint when the information CG model is placed in the position corresponding to the position information in the virtual space. The viewpoint information and the position information are given from an arbitrary device provided on the outsurface (e.g. external device). The CG model attitude controller 8 corresponds to a CG model attitude determiner and an information receiver of the present invention. The CG model having the meta-information (that is, the first and second display information) placed, in accordance with each attribute, on the first and second surfaces respectively is called an information CG model.

The CG model attitude controller 8 freely controls the attitude of the information CG model so that the information CG model having an arbitrary attitude is visible from the virtual viewpoint. The attitude is controlled to be changed into one of the following attitudes:

(1) An attitude in which the first surface seems the largest from the viewpoint;

(2) An attitude in which the second surface seems the largest from the viewpoint;

(3) An attitude in which the visual line and the first surface are perpendicular to each other;

(4) An attitude in which the visual line and the second surface are perpendicular to each other;

(5) An attitude in which the first surface is visible and the second surface is maximally invisible (the second surface is invisible or seems maximally small) from the viewpoint; and

(6) An attitude in which the second surface is visible and the first surface is maximally invisible (the first surface is invisible or seems maximally small) from the viewpoint.

The attitudes (1) and (2) can be realized by calculating the attitude in which an orthographically-projected area to a determined surface by the corresponding sid of the information CG model becomes the maximum, the determined surface being defined to be perpendicular to a visual line.

The attitudes (3) and (4) can be realized by calculating a rotation angle at which the normal line of the corresponding surface corresponds to the vector of the visual line and amending the attitude in accordance with the rotation angle.

The controls (5) and (6) can be realized by performing a calculation similar to that of the attitudes (1) and (2) under a constrained condition in which the orthographically-projected area of one of the corresponding surfaces is made maximally large and the orthographically-projected area of the other surface is maximally made small.

Note that the implementation method explained above is merely one example, and the present invention is not limited thereto.

### <Visualization Unit>

The visualization unit 9 places the information CG model having the attitude determined by the CG model attitude controller 8 in the position corresponding to the CG model position information in the CG space, and displays the CG space having the information CG model from the viewpoint corresponding to the viewpoint information. Concretely, the visualization unit 9 renders the CG space having the information CG model as an image seen from a specified viewpoint, and displays the rendered image on the screen of a display device (a television, for example). The visualization unit 9 corresponds to a CG model placer and a display of the present invention.

### Effect of First Embodiment

FIG. 5 is a diagram to explain the effect of the information visualization device according to the first embodiment.

When the information CG model is controlled, as shown in FIG. 5(1)-(a), to have an attitude in which the first surface is visible and the second surface is maximally invisible from the viewpoint, the CG model is visualized from the viewpoint as shown in FIG. 5(1)-(b). In this case, the first surface is visible, and the meta-information items, namely a program title, thumbnail image, broadcasting station name, genre, and program information, of the content item (a television program in this example) are visible.

On the other hand, when the information CG model is controlled as shown in FIG. 5(2)-(a) to have an attitude in which the second surface is visible and the first surface is maximally invisible from the viewpoint, the meta-information items, namely the program title and thumbnail image, of the content item (a television program in this example) are visible as shown in FIG. 5(2)-(b).

As stated above, in the information visualization device according to the first embodiment of the present invention, when information on target content item is visualized in a three-dimensional space by using a 3D CG technique, the surfaces visible from the viewpoint are controlled corresponding to the situation, by which display information having a different information amount can be accordingly displayed to a user.

The control can be performed more effectively by using a CG model having an angle of 90 degrees or less between the first surface and the second surface. In this case, the first surface is visible with the second surface being invisible, or the second surface is visible with the first surface being invisible.

In the present embodiment, the meta-information (first and second display information) is placed on the first surface and the second surface, and the attitude of the CG model is controlled so that the first or second surface is visible. However, in the present invention, it is naturally possible to place the meta-information on three or more surfaces, for example, and to control the attitude of the CG model so that one of these surfaces is visible.

Further, although every surface of the CG model is plane in the present embodiment, the surfaces of the CG model can be curved.

In the technique of JP-A 2004-178085 (Kokai) described in the background art section, display information of the content item can be changed only when the “apparent size” of the display of the program changes. However, in the information visualization device according to the first embodiment of the present invention, even when the “apparent size” of the display of the program does not change, the content information to be displayed can be changed. The “apparent size” of the display of the program does not change in the following cases, for example:

(1) When the size of the first surface and the second surface are same: this is because, in the visualization device according to the first embodiment of the present invention, the technical logic to change the display information does not depend on the size of the first surface and the second surface;

(2) When the first surface and the second surface are the same in size but are different in form: a reason similar to that of the above case; and

(3) When the first surface and the second surface are the same in size but are different in attitude: a similar reason to the above can be applied;

In the three-dimensional space, the “apparent size” does not necessarily correspond to the position and size of the CG model. This is because the concept of the “apparent size” can be formed only by determining the viewpoint information showing the viewpoint from which the three-dimensional space is visualized. When it is purely required to change the display information according to the position and size of the CG model in the three-dimensional space, the technique of JP-A 2004-178085 (Kokai) cannot be used. On the contrary, in the information visualization device according to the first embodiment of the present invention, it is possible to provide a visualization technique capable of changing the display information in such a situation by changing the attitude in accordance with the conditions of the position and size of the CG model in the three-dimensional space.

Further, in the information visualization device according to the first embodiment of the present invention, it is possible to make the first surface and the second surface visible at the same time by controlling the attitude. In the example explained hereinbefore, the meta-information placed on the first surface and the meta-information placed on the second surface have some elements in common. When the common elements are not existent, it is possible, by switching the attitude, to display one type of display information on the first surface (when only the first surface is invisible due to a geometric form of the CG model, the first surface is visible and the second surface is maximally invisible from the viewpoint), to display the other type of display information on the second surface (the supplementary explanation concerning the first surface can be applied), and to display both types of display information on the first surface and the second surface at the same time. This is a new effect which cannot be achieved by JP-A 2004-178085 (Kokai).

Here, when many content information items are visualized in the three-dimensional space by using the CG model and every content item is displayed having the same information amount, it is difficult to distinguish each content item at one view. It is possible to distinction each content item by controlling the visible surface corresponding to some references, such as the importance or relevance ratio of the content item with the technique of the present invention. For example, it is possible to place on the first surface detailed display information formed of various meta-information items, and to place on the second surface simplified display information formed of a small number of meta-information items, by which the information having a high importance is visible on the first surface and the information without a high importance is visible on the second surface. Accordingly, even when many content items are displayed, each content item can be distinguished at one view, which is an extremely effective aspect.

Explained in the following is a concrete example in which the display information is controlled so that the target content item selected from a plurality content items and the content items having a high relevance ratio to the target content item are visible on the first surface, and the other content items are visible on the second surface.

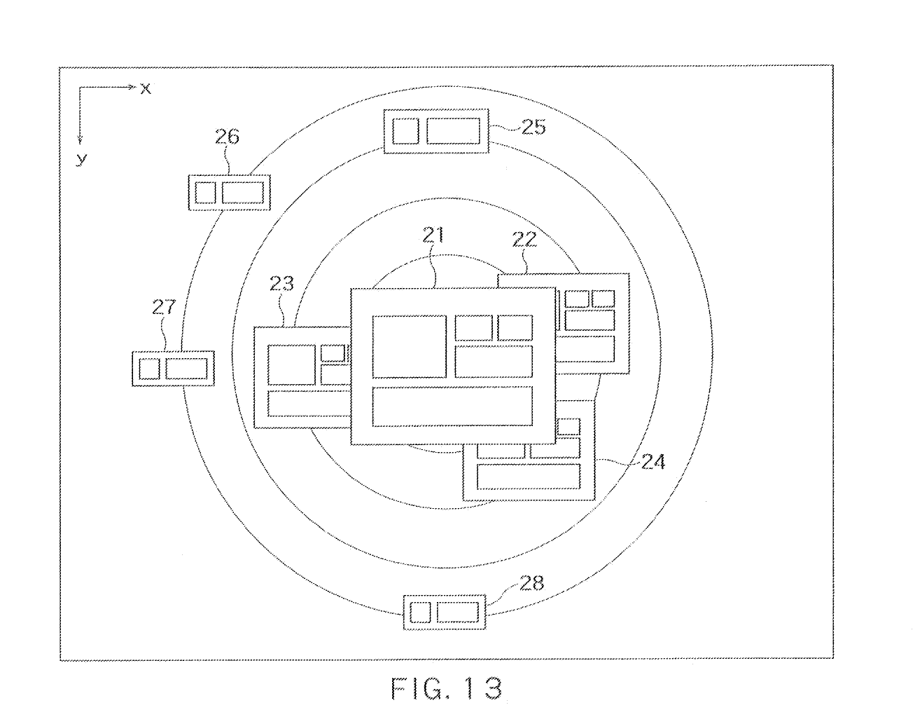

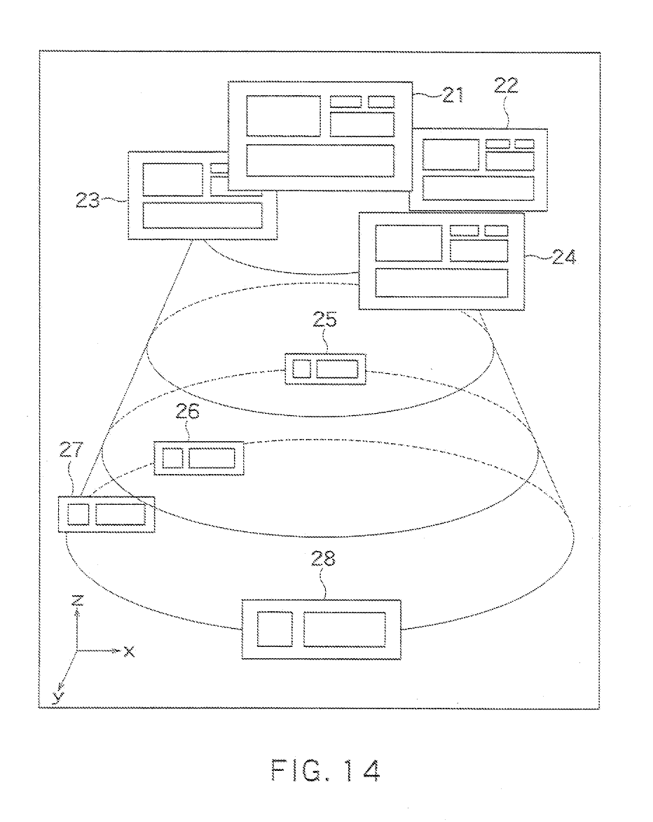

Each of FIGS. 13 and 14 shows an example in which information CG models 21 to 28 are placed in the virtual space. FIG. 13 shows a view from the upper surface (the point which is on the far positive surface of the Z-axis) of the virtual space. This state corresponds to first viewpoint information. FIG. 14 shows a view of the same space as in FIG. 13 seen from the front, namely, from the point which is on the far positive surface of the Y-axis and is slightly on the positive surface of the Z-axis. This state corresponds to second viewpoint information. A conically-shaped placement coordinate system is placed in the virtual space, and the information CG models are placed in the conically-shaped placement coordinate system. Each of the directions X and Y on the plane represents genres (which are types of meta-information items).

The information CG models 21 to 28 are is generated from the same CG model acquired by the CG model obtainer 1.

In each of FIGS. 13 and 14, eight information CG models 21 to 28 are placed. That is, the eight information CG models 21 to 28 are generated from the eight content items specified by a content obtainer 13. Each of the eight the generated information CG models 21 to 28 is placed in the position corresponding to the position information thereof. The placement of FIG. 13 is visible when the first viewpoint information is given to the CG model attitude controller 8, and the placement of FIG. 14 is visible when the second viewpoint information is given to the CG model attitude controller 8.

The position information of each of the information CG models 21 to 28 is calculated by a position information calculator (not shown) provided on the outsurface. The position information calculator specifies the target content item (corresponding to the information CG model 21 in this case) from the content database 2, determines the target content item as a reference, and calculates the relevance ratio of the target content item to the other content items (content items corresponding to the information CG models 22 to 28). The relevance ratio can be calculated by an arbitrary method. For example, the relevance ratio can be obtained by calculating a function in which each meta-information item of the target content item and the other content items is used as an argument. The position information calculator determines the placement position of the information CG model 21, which corresponds to the target content item, to be (x, y, z)=(0, 0, 1), and determines the placement positions of the other content items, namely the information CG models 22 to 28, according to the genres and relevance ratios thereof. Concretely, the z-coordinate is determined so that the Z value approaches 1 as the relevance ratio becomes larger and approaches 0 as the relevance ratio becomes smaller, the bottom face of the cone is generated to pass through the determined z-coordinate, and each of the x-coordinate and the y-coordinate is determined by the intersecting point between the outer circumference of the bottom face and the direction line depending on the genres on the X-Y plane.

In this case, the CG model attitude controller 8 acquires, from the position information calculator arranged on the outsurface, the relevance ratio of the target content item to each of the other content items, and determines to display the target content item on the first surface and to display each of the other content items on the first surface or the second surface corresponding to the level of its relevance ratio to the target content item. For example, the CG model attitude controller 8 determines to display on the first surface the content item whose relevance ratio to the target content item is equal to or greater than a threshold value, and to display on the second surface the content item whose relevance ratio to the target content item is less than the threshold value. In the example in each of FIGS. 13 and 14, the information CG model 21 serving as the target content item, and the information CG models 22 to 24 having a relevance ratio of equal to or greater than the threshold value, are determine to be displayed on the first surface, and the information CG models 25 to 28 having a relevance ratio of less than the threshold value are determined to be displayed on the second surface.

In this way, the CG model attitude controller 8 determines the attitude of each information CG model based on the information determined for each information CG model concerning the surface and placement position to be displayed to the user and the viewpoint information given from the outsurface. The visualization unit 9 places each information CG model having the determined attitude in the placement position, and displays the CG space having each information CG model from the viewpoint corresponding to the viewpoint information.

### FIRST MODIFICATION EXAMPLE OF FIRST EMBODIMENT

The block diagram of an information visualization device according to a first modification example of the first embodiment is similar to that of FIG. 1. The processes performed by the first surface meta-information selector 4 and the second surface meta-information selector 5 are partially expanded. Hereinafter, these expanded processes will be explained.

### <Expanded Process Performed by First Surface Meta-Information Selector>

In addition to the operation explained in the first embodiment, the first surface meta-information selector 4 performs a media conversion to display the selected meta-information item as a symbol according to need.

Concretely, when a genre name is selected as a meta-information item, the selected meta-information item is replaced with an icon image corresponding to the genre name. In other words, the media conversion is performed to convert the character string information into the image information. In this case, the media conversion is performed in accordance with a predetermined rule. The predetermined rule is recorded in the first surface meta-information selector 4. Note that the media conversion can be performed by using the information obtained from the outsurface as well as the predetermined rule. For example, when the media conversion is performed to convert the character string of a broadcasting station name into an icon representing the broadcasting station, the icon representing the broadcasting station is generally distributed with being included in a digital terrestrial television signal. Accordingly, an icon image for the broadcasting station name (meta-information item of the content item) is acquired from the digital terrestrial television signal (outsurface), and the acquired icon image is used. In other words, the icon image is obtained from the digital terrestrial television airwaves by using the rule that the icon images included in the digital terrestrial television signal, the rule being stored in the database.

### <Expanded Process Performed by Second Surface Meta-Information Selector>

An expanded process performed by the second surface display information selector 5 is similar to that performed by the first surface meta-information selector 4. Accordingly, the explanation on the expanded process performed by the second surface meta-information selector 5 will be omitted.

### EFFECT OF FIRST MODIFICATION EXAMPLE OF FIRST EMBODIMENT

In the information visualization device according to the first modification example of the first embodiment, not only formats corresponding to the selected meta-information items but also a variety of changeable formats can be used to display the information on the first surface and the second surface of the CG model. For example, when visualize the content information, the visualization image showing only character information does not help the user to specify the content item at one view and forces the user to read the characters, but the visualization image showing an icon enables the user to specify the content information at one view. In other words, even when the meta-information of the content is not distributed as rich media information, the meta-information of the content can be visualized as rich media information.

### SECOND MODIFICATION EXAMPLE OF FIRST EMBODIMENT

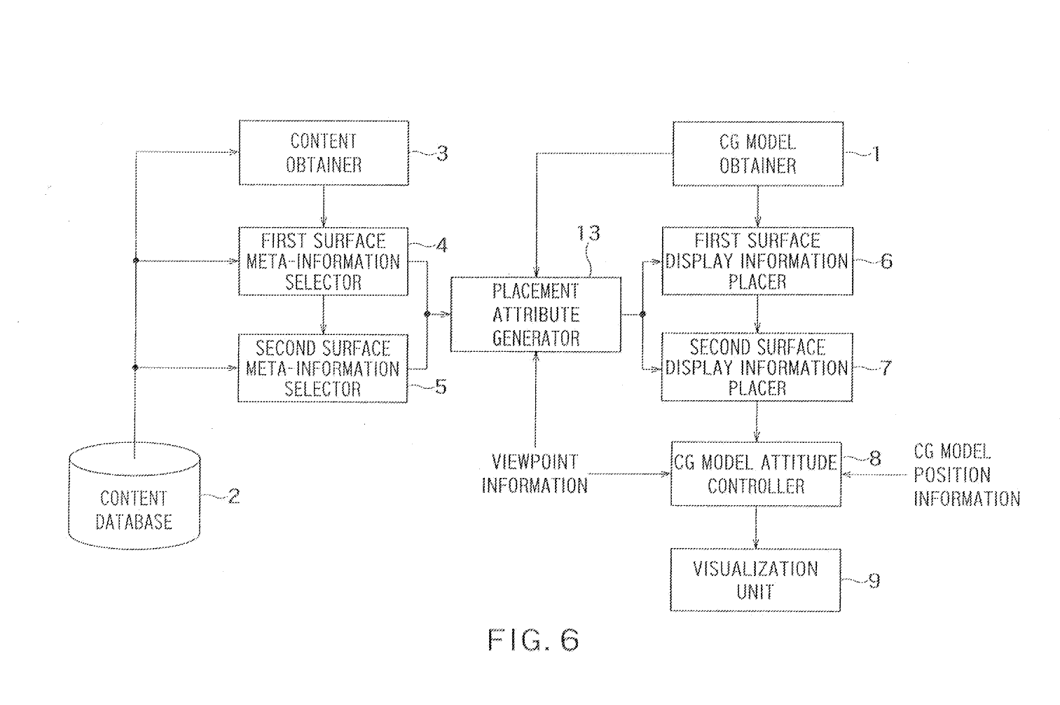

FIG. 6 shows an overall block diagram of an information visualization device according to a second modification example of the first embodiment of the present invention.

The information visualization device of the second modification example is obtained by newly adding, to the information visualization device according to the first embodiment, a placement attribute generator 13 to generate the placement attributes of the meta-information item. Hereinafter, only the differences from the first embodiment will be explained.

### <Placement Attribute Generator>

The placement attribute generator 13 generates the placement attributes to place the meta-information items on the first surface or the second surface in accordance with the characteristic of the CG model or the characteristic of the viewpoint information. Here, the characteristic of the CG model or the viewpoint information is one of the following characteristics:

(1) The size (actual size) of the surface (first surface or second surface);

(2) The form (actual form) of the surface (first surface or second surface);

(3) The size (apparent size) of the surface (first surface or second surface) seen from the viewpoint; and

(4) The form (apparent form) of the surface (first surface or second surface) seen from the viewpoint.

More specifically, the characteristics (1) and (2) relate to the CG model, while the characteristics (3) and (4) relate to both of the CG model and the viewpoint information.

Hereinafter, explanation will be made based on an example of “(1) the size (actual size) of the surface (first surface or second surface).” A similar explanation can be applied to the other cases.

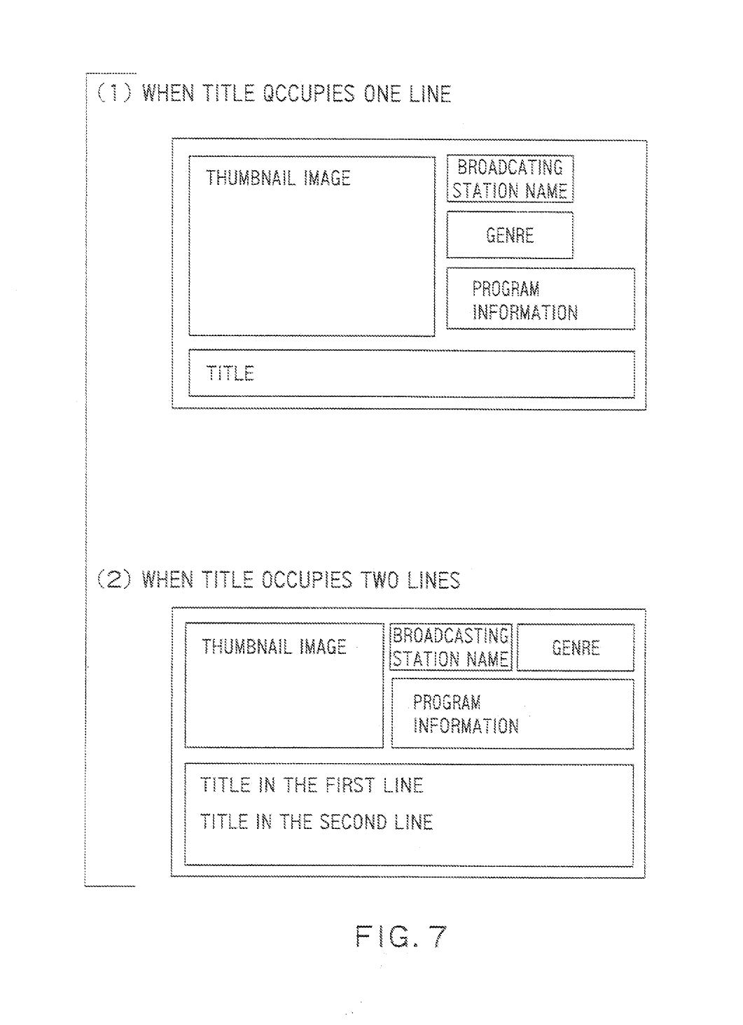

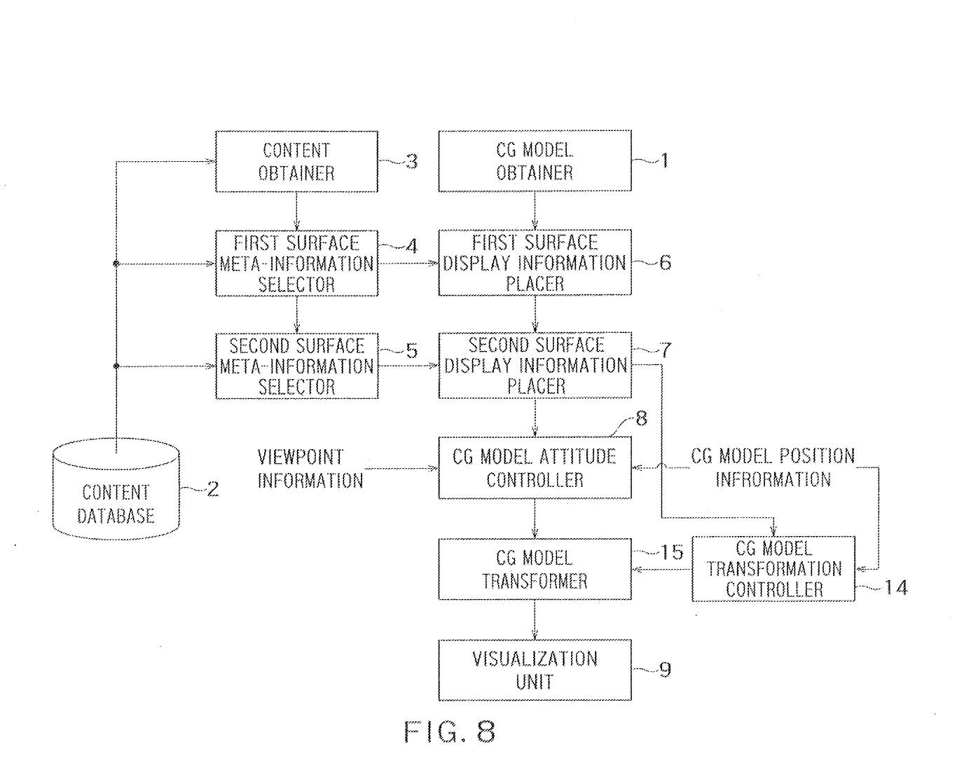

Taking the size of the surface into consurfaceration, for example, the placement attribute generator 13 adaptively changes the position and size of the placement region of every meta-information item. For example, the meta-information items are a program title, thumbnail image, broadcasting station name, genre name, and program information. The placement attribute generator 13 previously retains a database concerning the priority of meta-information items, and dynamically generates the placement attributes concerning the placement position etc. in the order starting from the meta-information item having the highest priority. The priority of meta-information items lowers in the above order. The rules to place the meta-information items are previously determined by the placement attribute generator 13 or given from the outsurface. In accordance with the rules determined in this case, the title is completely displayed in the lower portion of the surface, the thumbnail image is displayed to be maximally large in the upper left portion of the surface, and the broadcasting station name, genre name, and program information are displayed as sufficiently as possible in the space on the right surface of the thumbnail. In this case, firstly, the placement attribute to place the program title at bottom of the surface is determined. In this case, for example, the size of the thumbnail is adaptively changed since the size of the area above the program title changes according to the number of lines of the program title. Further, the placement attributes of the broadcasting station name and genre name are determined reacting on the above placement attributes, and finally the program information is displayed in a limited number of lines in a remained space, which means that the placement attributes are dynamically changed in accordance with the meta-information items. FIG. 7 shows how the placement attributes are dynamically changed corresponding to the number of lines of the title. FIG. 7(1) shows a case where the title is displayed in one line, and FIG. 7(2) shows a case where the title is displayed in two lines.

### EFFECT OF SECOND MODIFICATION EXAMPLE OF FIRST EMBODIMENT

In the information visualization device according to the second modification example of the first embodiment, the meta-information items can be placed (display information items can be combined) not only by using the placement attributes statically predetermined, but also by dynamically changing the placement attributes in corresponding to the meta-information items.

### Second Embodiment

FIG. 8 shows an overall block diagram of an information visualization device according to a second embodiment of the present invention.

In addition to the components of the information visualization device according to the first embodiment, the information visualization device of the present embodiment further includes: a CG model transformation controller 14 to control the transformation of the CG model; and a CG model transformer 15 to transform the CG model in accordance with the control performed by the CG model transformation controller 14.

Hereinafter, only the differences from the first embodiment will be explained.

### <CG Model Transformation Controller>

The CG model transformation controller 14 controls the transformation of the information CG model having an attitude controlled by the CG model attitude controller 8 by using the viewpoint information for visualization and the position information of the CG model.

As explained in the first embodiment, the relationship (topology) between the first surface and the second surface is statically determined in accordance with the geometric form of the CG model. Accordingly, in some cases, due to the form of the CG model, the following is impossible that the first surface is always visible and the second surface is always invisible from a certain viewpoint, for example. In such a case, the CG model transformation controller 14 transforms the CG model so that the first surface is always visible and the second surface is always invisible from a certain viewpoint.

Concretely, the CG model transformation controller 14 calculates the transformation parameters of the CG model to realize one of the following conditions, and transmits the calculated transformation parameters to the CG model transformer 15.

(1) The direction of the second surface is changed so that the second surface is invisible in the attitude in which the first surface is visible from the viewpoint with the connection between the surfaces being kept as much as possible.

(2) The direction of the first surface is changed so that the first surface is invisible in the attitude in which the second surface is visible from the viewpoint with the connection between the surfaces being kept as much as possible.

(3) The direction of the second surface is changed so that the second surface is visible in the attitude in which the first surface is visible from the viewpoint with the connection between the surfaces being kept as much as possible.

(4) The direction of the first surface is changed so that the first surface is visible in the attitude in which the second surface is visible from the viewpoint with the connection between the surfaces being kept as much as possible.

The above conditions (1) to (4) can be realized by moving the vertexes (or polygon) connected to the second (or first) surface and moving the vertexes of the second (or first) surface so that the angle between the normal line vector of the second (or first) surface and the visual line vector becomes 90 degrees or less (or greater) and the second. (or first) surface is visible (or invisible) while the first (or second) surface is kept visible.

### <CG Model Transformer>

The CG model transformer 15 transforms the CG model in accordance with the control performed by the CG model transformation controller 14. Concretely, the CG model transformer 15 rewrites the information of the CG model in accordance with the transformation parameters sent from the CG model transformation controller 14, and transforms the geometric form of the CG model. Here, the information of the CG model to be rewritten is, for example, vertex information, surface information (or information of connected vertexes), primitive information (or technical information to connect the vertexes), material information, color information, texture information, etc.

### Effect of Second Embodiment

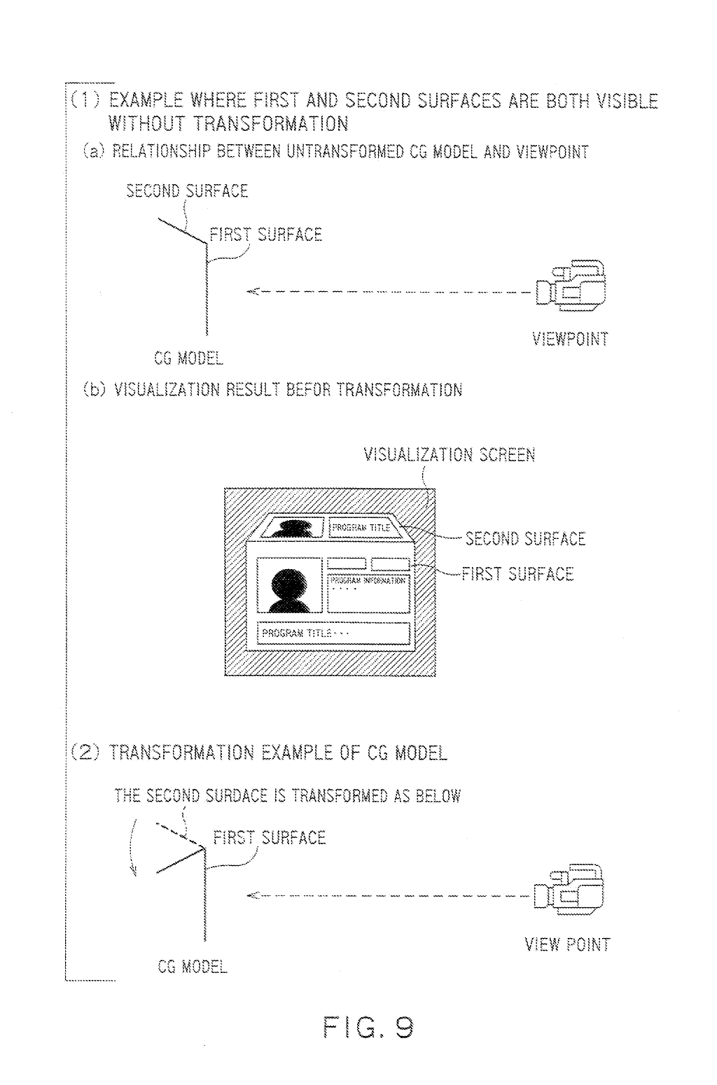

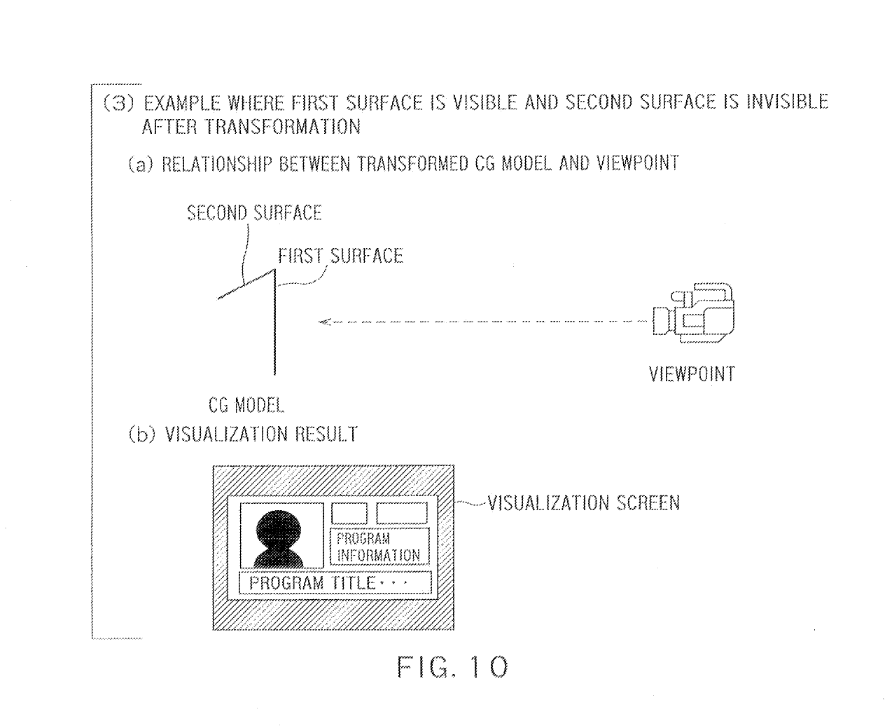

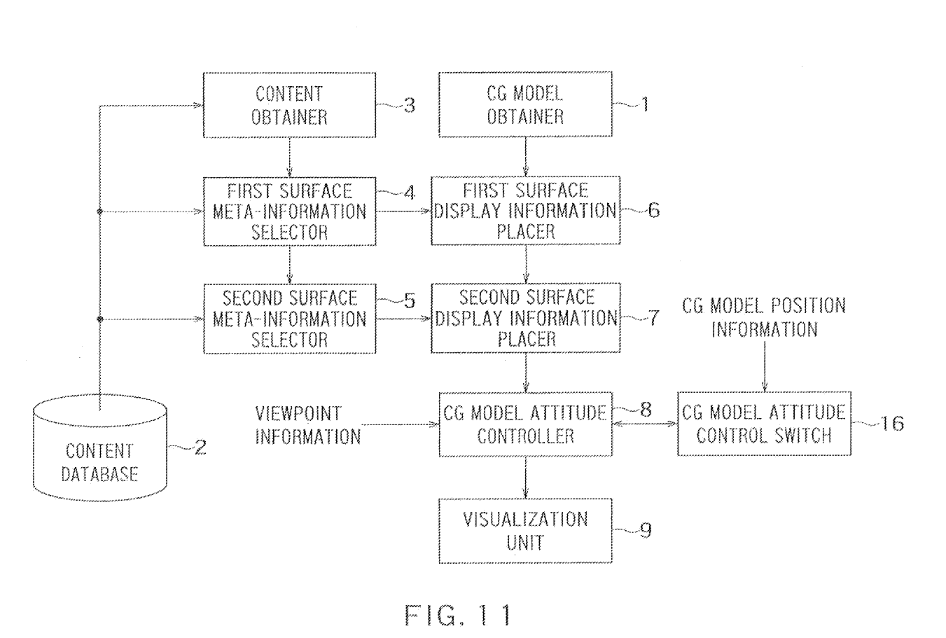

Each of FIGS. 9 and 10 is a diagram to explain the effect of the information visualization device according to the second embodiment.

As shown in FIG. 9(1), when the attitude of the information CG model having four surfaces is controlled so that the first surface seems the largest, both of the first surface and the second surface are visible. As shown in FIG. 9(2), the CG model transformer 15 changes the direction of the second surface with the first surface being kept visible from the viewpoint so that the second surface is invisible. Thereby, the first surface is visible and the second surface is invisible as shown in FIG. 10(3).

As stated above, in the information visualization device according to the second embodiment of the present invention, the following situations can be achieved with respect to every information CG model.

(1) The display information on the first surface is always visible and the display information on the second surface is always invisible;

(2) The display information on the second surface is always visible and the display information on the first surface is always invisible; and

(3) The display information on the first surface is always visible and the display information on the second surface is always visible.

### Third Embodiment

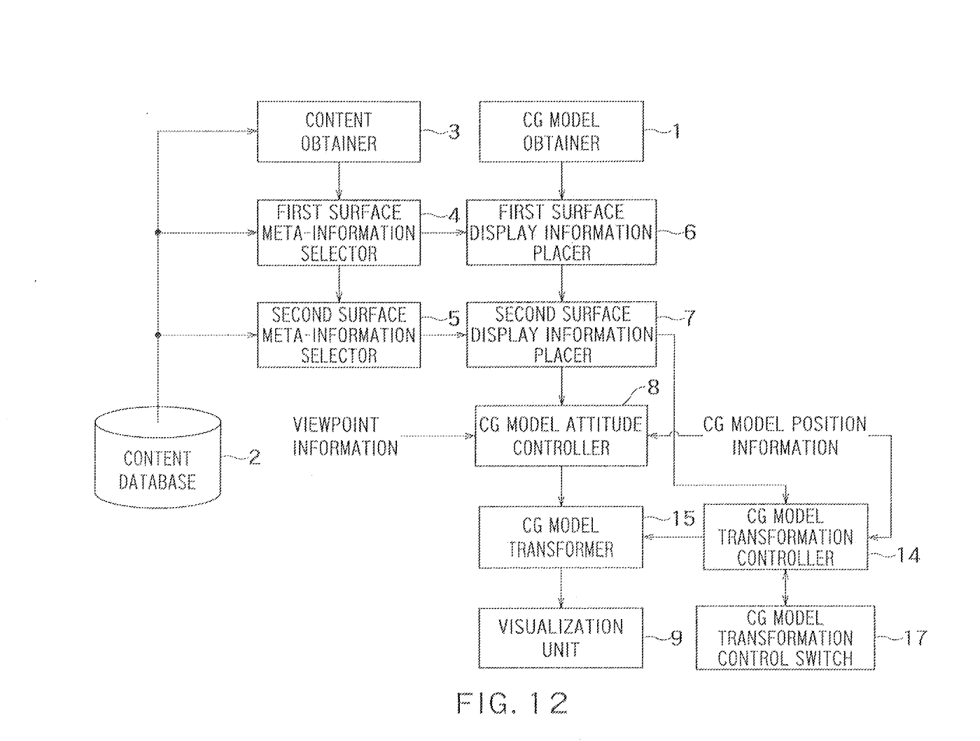

FIG. 11 shows an overall block diagram of an information visualization device according to a third embodiment of the present invention.

In addition to the components of the information visualization device according to the first embodiment, the information visualization device of the present embodiment further includes a CG model attitude control switch 16 which selects an attitude of the CG model from a plurality of attitudes and presents a control indication of the selected attitude to the CG model attitude controller 8. The CG model attitude control switch 16 corresponds to an attitude indicator of the present invention, for example. Hereinafter, only the differences from the first embodiment will be explained.

### <CG Model Attitude Control Switch>

The CG model attitude control switch 16 selects, corresponding to an indication (for example, user indication) from the outsurface, either of the attitude in which the first surface is always visible and the second surface is maximally invisible from the viewpoint for visualization and the attitude in which the first surface is maximally invisible and the second surface is always visible from the viewpoint for visualization, and presents the control indication of the selected attitude to the CG model attitude controller 8.

The CG model attitude control switch 16 calculates and stores the following conditions by using the information of the first surface and the second surface of the CG model and the information of the viewpoint for visualization:

(1) A condition to control the attitude so that “the first surface is always visible and the second surface is maximally invisible from the viewpoint for visualization”; and

(2) A condition to control the attitude so that “the second surface is always visible and the first surface is maximally invisible from the viewpoint for visualization.”

The calculation technique is as explained in the <the CG model attitude controller> section of the first embodiment.

Then, the above conditions (1) and (2) are switched in accordance with the indication (user indication, for example) from the outsurface, and a control indication for each attitude is given to the CG model attitude controller 8. The CG model attitude controller 8 controls the attitude of the CG model in accordance with the control indication.

### Effect of Third Embodiment

In the information visualization device according to the third embodiment of the present invention, the user can observe the meta-information items obtained by properly switching the meta-information items (first display information) on the first surface and the meta-information items (second display information) on the second surface.

### FIRST MODIFICATION EXAMPLE OF THIRD EMBODIMENT

FIG. 12 shows an overall block diagram of an information visualization device according to a first modification example of the third embodiment of the present invention.

In addition to the components of the information visualization device according to the second embodiment (see FIG. 8), the information visualization device of the present embodiment further includes a CG model transformation control switch 17 which selects a transformation of the CG model from a plurality of transformations, and presents a control indication of the selected transformation to the CG model transformation controller 14. The CG model transformation control switch 17 corresponds to a transformation indicator of the present invention, for example.

### <CG Model Transformation Control Switch>

The CG model transformation control switch 17 calculates and stores the following conditions by using the information of the first surface and the second surface of the CG model and the information of the viewpoint for visualization:

(3) A condition to control the transformation so that “the first surface is always visible and the second surface is maximally invisible from the viewpoint for visualization”; and

(4) A condition to control the transformation so that “the second surface is always visible and the first surface is maximally invisible from the viewpoint for visualization.”

The calculation technique is as explained in the <the CG model transformation controller> section of the second embodiment.

Then, the above conditions (3) and (4) are switched in accordance with the indication (user indication, for example) from the outsurface, and a control indication for each transformation is given to the CG model transformation controller 14. The CG model transformation controller 14 controls the transformation of the CG model in accordance with the indication.

### EFFECT OF FIRST MODIFICATION EXAMPLE OF THIRD EMBODIMENT

In the information visualization device according to the third embodiment of the present invention, the user can observe the meta-information items obtained by properly switching the meta-information items (first display information) on the first surface and the meta-information items (second display information) on the second surface.

The processes in the embodiments of the present invention can be realized by using a program which can be executed by a computer. The program can be stored in a storage medium readable for the computer.

The storage medium in the present invention is not limited as long as the storage medium stores a program and be readable by a computer or an installed system. The storage medium is, for example, a magnetic disk, floppy disk, hard disk, optical disk (CD-ROM, CD-R, DVD, etc.), magnetic optical disk (MO etc.), semiconductor memory, etc.

Further, each process to realize the present embodiment can be partially executed by the operation system working on a computer based on the instructions by a program installed from a storage medium into the computer or an embedded system, database-management software, middleware such as a network, etc.

Further, the storage medium in the present invention is not limited to a medium independent of a computer or an embedded system. Also included is a storage medium storing or temporarily storing a program downloaded through a LAN, the Internet, etc.

Furthermore, the number of storage media employed is not limited to one. A plurality of media can be used to carry out the process of each embodiment of the present invention.

The computer or embedded system of the present invention is provided to carry out the process of each embodiment based on the program stored in a storage medium. A device having one of a personal computer, microcomputer, etc., a system in which a plurality of devices are network-connected, etc. can also be employed to carry out the process.

Further, the computer in the present invention is not limited to a personal computer and covers equipment or a device capable of realizing the functions of the present invention through a program, such as an arithmetic processing unit, microcomputer, etc. serving as an information processing device.

Note that the present invention is not limited to the above embodiments, and can be variously transformed and carried out without departing from the scope of the invention. Further, various levels of inventions are included in the above embodiments, and various inventions can be extracted by properly combining a plurality of constituent features disclosed.

What is claimed is claims:

1. An information visualization device which places and displays a CG model having two or more surfaces in a virtual space, comprising:
a content database storing one or more content items, each of which including a plurality of meta-information items;
a content specifier configured to specify a desired content item in the content database;
a first display information generator configured to generate first display information by combining one or more first meta-information items out of the meta-information items included in the desired content item;
a second display information generator configured to generate second display information by combining one or more second meta-information items out of the meta-information items included in the desired content item, the second display information having a different information amount from that of the first display information;
a display information placer configured to generate an information CG model by placing the first display information on a first surface of the CG model and by placing the second display information on a second surface of the CG model, the first surface and the second surface being different from each other;
an information receiver configured to receive information representative of a virtual viewpoint and position information of the information CG model in the virtual space from an external device;
a CG model attitude determiner configured to determine an attitude of the information CG model in the virtual space so that the first surface or the second surface is visible from the virtual viewpoint when the information CG model is placed according to the position information in the virtual space;
a CG model placer configured to place the information CG model with a determined attitude in the virtual space according to the position information; and
a display configured to display the information CG in the virtual space from the virtual viewpoint.

2. The device according to claim 1, wherein the CG model attitude determiner determines the attitude of the information CG model so that one of the first surface and the second surface is visible and the other is invisible from the virtual viewpoint.

3. The device according to claim 2, further comprising an attitude indicator configured to select either one attitude of a first attitude or a second attitude correspondingly to a selection signal given from an external device and indicate the one attitude to the CG model attitude determiner, the first attitude making the first surface visible and the second surface invisible and the second attitude making the second surface visible and the first surface invisible,
wherein the CG model attitude determiner determines the attitude of the information CG model in accordance with indication from the attitude indicator.

4. The device according to claim 2, wherein when there is no attitude in which the one surface is visible and the other surface is invisible, the CG model attitude determiner determines the attitude so that the other surface seems maximally small.

5. The device according to claim 4, further comprising an attitude indicator configured to select either one attitude of a first attitude or a second attitude correspondingly to a selection signal given from an external device and indicate the one attitude to the CG model attitude determiner, the first attitude making the first surface visible and the second surface invisible or seem maximally small and the second attitude making the second surface visible and the first surface invisible or seem maximally small,
wherein the CG model attitude determiner determines the attitude of the information CG model in accordance with indication from the attitude indicator.

6. The device according to claim 1, further comprising a CG model transformation processor,
wherein the CG model attitude determiner determines the attitude of the information CG model so that one of the first surface and the second surface is visible and the other is invisible from the virtual viewpoint, and
wherein when the CG model attitude determiner determines that such an attitude is not existent, the CG model transformation processor transforms the information CG model so that the one surface is visible and the other surface is invisible from the virtual viewpoint.

7. The device according to claim 6, wherein the CG model transformation processor transforms the information CG model so that the one surface seems maximally large from the virtual viewpoint.

8. The device according to claim 6, further comprising a transformation indicator configured to select either one transformation of a first transformation making the first surface visible and the second surface invisible or a second transformation making the second surface visible and the first surface invisible correspondingly to a selection signal given from an external device, and indicate the one transformation to the CG model transformation processor,
wherein the CG model transformation processor transforms the information CG model in accordance with indication from the transformation indicator.

9. An information visualization method which places and displays a CG model having two or more surfaces in a virtual space, comprising:
accessing a content database storing one or more content items, each of which including a plurality of meta-information items;
specifying a desired content item in the content database;
generating first display information by combining one or more first meta-information items out of the meta-information items included in the desired content item;
generating second display information by combining one or more second meta-information items out of the meta-information items included in the desired content item, the second display information having a different information amount from that of the first display information;
generating an information CG model by placing the first display information on a first surface of the CG model and by placing the second display information on a second surface of the CG model, the first surface and the second surface being different from each other;
receiving information representative of a virtual viewpoint and position information of the information CG model in the virtual space from an external device;
determining an attitude of the information CG model in the virtual space so that the first surface or the second surface is visible from the virtual viewpoint when the information CG model is placed according to the position information in the virtual space;
placing the information CG model with a determined attitude in the virtual space according to the position information; and
displaying the information CG model in the virtual space from the virtual viewpoint.
